(19) United States
(12) Patent Application Publication
(10) Pub. No.: US 2003/0072260 A1
(43) Pub. Date: Apr. 17, 2003

(54) Multi-dimensional buffer management hierarchy

(76) Inventors: Mark William Janoska, Carleton Place (CA); Henry Chow, Kanata (CA); Hossain Pezeshki-Esfahani, Ottawa (CA)

Correspondence Address: Shapiro Cohen, Station D, P.O. Box 3440, Ottawa, ON, K1P 6P1, CA

(21) Appl. No.: 09/969,810

(22) Filed: Oct. 4, 2001

Related U.S. Application Data
(60) Provisional application No. 60/238,038, filed on Oct. 6, 2000.

(51) Int. Cl. G01R 31/08

(52) U.S. Cl. 370/229; 370/230

(57) ABSTRACT

A congestion management system that controls access to any shared resource by incoming data transmission units. The access can be controlled based on the particular connection associated with a data transmission unit. Every shared resource, such as a pool of buffer memory, is represented by a partition. The congestion management system is comprised of a plurality of connection data structures and a plurality of partition data structures. Each connection data structure represents a particular connection and, similarly, each partition data structure represents a particular partition. Each incoming DTU is associated with a single connection but may be allowed access to more than one partition. Each partition is associated with a shared resource and access to each partition is governed by the state of a partition data structure. If a partition data structure indicates that a specific threshold has been met, then access to the shared resource by other DTUs is denied. Depending on the priority level enforced a DTU may be accepted or rejected based on the priority level of the DTU. It should be mentioned that the priority level enforced may change depending on the number of DTUs that are currently accessing the resource.

This application relates to U.S. Provisional Patent Application 60/238,038 filed Oct. 6, 2000.

### FIELD OF INVENTION

The present invention relates to congestion control in a data traffic management system. More particularly, the invention relates to controlling data access to the buffer resources of a data traffic management system based on the amount of data buffered in the data traffic management system.

### BACKGROUND TO THE INVENTION

In the field of data communications, there are many types of data traffic protocols such as Asynchronous Transfer Mode (ATM), Frame Relay, and Multi Protocol Label Switching (MPLS), that may be implemented in a data network. These protocols share a common purpose—to allow the transmission and reception of data traffic at various nodes in a data network. A data traffic management system can be useful at any given node in managing the fluctuating volume of data traffic being transmitted through the node. In managing the data traffic at a given node, the data traffic management system has three primary functional responsibilities: buffering incoming data, managing the volume of incoming data traffic, and scheduling the departure of data from the node. To perform these functions, a data traffic management system typically has three main functional components, a congestion management system, a buffer management system, and a scheduling system.

Regardless of the protocol used to encapsulate the data arriving at a given node, the data traffic management system can process many different classes of data traffic comprised of many data transmission units which arrive at the node from other nodes in the network. Throughout this document, the term data transmission unit (DTU) will be used in a generic sense to mean units which encapsulate data. Thus, such units may take the form of packets, cells, frames, or any other unit as long as data is encapsulated within that unit. Furthermore, it is understood that data traffic is to be composed of streams of DTUs.

The data traffic management system uses a congestion management system to monitor the volume of incoming data traffic. A congestion management system is also designed to control the access of various DTUs to shared resources such as buffer memory. The congestion management system is particularly useful when there is a large number of DTUs trying to gain access to the shared resources of the data traffic management system. The congestion management system determines whether to accept or reject DTUs arriving from a particular connection based on the amount of DTUs trying to gain access to the data traffic management system.

In one known implementation of the congestion management system, the congestion management system will reject a particular DTU attempting to gain access to a resource if the available resource, such as the buffer memory, is full or cannot accept any more DTUs. In this scheme, each incoming DTU is considered on a first-come-first-served basis. DTUs are therefore not distinguished based on their origin or level of importance with respect to the other incoming DTUs. This distinction is important since some DTUs may be vital to the system and should therefore merit preferential treatment. As a result, it is inadvisable to implement the first-come-first-served technique since DTUs with a high priority level may be discarded while DTUs with a low priority level may be allowed access when congestion levels are high.

Another shortcoming of the known implementation of the congestion management system is that buffer memory is not divided into separate pools. Dividing the buffer memory into separate pools allows the dedication of specific pools of buffer memory to DTUs with a high priority level or, to DTUs that transmit through a particular connection. In addition to the above, the congestion management system could isolate these dedicated buffer memory pools to thereby guarantee a portion of these memory pools for DTUs which have a high priority level.

The present invention seeks to overcome these shortcomings by providing a congestion management system which reserves resources for higher priority level data traffic and manages to segregate resources and in order to manage them as separate partitions.

### SUMMARY OF THE INVENTION

The present invention seeks to provide a congestion management system that controls access to any shared resource by incoming data transmission units. The access con be controlled based on the particular connection associated with a data transmission unit. Every shared resource, such as a pool of buffer memory, is represented by a partition. The congestion management system is comprised of a plurality of connection data structures and a plurality of partition data structures. Each connection data structure represents a particular connection and, similarly, each partition data structure represents a particular partition. Each incoming DTU is associated with a single connection but may be allowed access to more than one partition. Each partition is associated with a shared resource and access to each partition is governed by the state of a partition data structure. If a partition data structure indicates that a specific threshold has been met, then access to the shared resource by other DTUs is denied. Depending on the priority level enforced a DTU may be accepted or rejected based on the priority level of the DTU. It should be mentioned that the priority level enforced may change depending on the number of DTUs that are currently accessing the resource.

In a first aspect, the present invention provides a congestion management system for controlling access of data transmission units to a plurality of shared resources, each data transmission unit having a priority level and being associated with a connection, and each shared resource being represented by a partition, the congestion management system including:

(a) a plurality of connection data structures, each connection data structure representing a connection, and each connection data structure having:

(a1) a connection depth counter which indicates a number of data transmission units currently active on the connection,

(a2) a predetermined number of connection priority level thresholds, each connection priority level threshold corresponding to a priority level assignable to a data transmission unit, and each connection priority level threshold being determinative of whether an incoming data transmission unit may be allowed on the connection based on a priority level of the incoming data transmission unit,

(a3) a maximum connection threshold indicating a maximum number of data transmission units that may be active at any one time on the connection, and

(a4) at least one pointer, the or each pointer referencing a partition associated with a connection represented by the connection data structure;

(b) a plurality of partition data structures, each partition data structure representing a partition, and each partition data structure having:

(b1) a partition depth counter which indicates a number or data transmission units currently active on the connection,

(b2) a predetermined number of partition priority level thresholds, each partition priority level threshold corresponding to a priority level assignable to a data transmission unit, and each partition priority level threshold being determinative of whether an incoming data transmission unit may be allowed on the connection based on the priority level of the incoming data transmission unit,

(b3) a maximum partition threshold indicating a maximum number of data transmission units that may be active at any time on a partition; and

(c) processing means for determining whether an incoming data transmission unit is allowed on a specific connection and a specific partition based on the priority level of the incoming data transmission unit, a connection priority level threshold, and a partition priority level threshold, for updating the plurality of connection data structures and updating the plurality of partition data structures when an incoming data transmission unit is allowed.

In a second aspect, the present invention provides a method for controlling access of a data transmission unit to at least one destination, the or each destination is represented by a partition, the data transmission unit being associated with a connection, the method including the steps of:

(a) determining if the data transmission unit can be accepted at the connection,

(b) determining if the data transmission unit can be accepted at the or each partition,

(c) if the data transmission unit is rejected at either the connection or at least one partition, rejecting the data transmission unit, and

(d) if the data transmission unit is accepted at the connection and at the or at all the partitions, accepting the data transmission unit such that the data transmitted unit is granted access to the or each destination.

In a third aspect, the present invention provides a method for updating a data traffic management system upon departure of a data transmission unit, the method including:

a) identifying a connection and at least one partition associated with a departing data transmission unit,

(b) decrementing by one a connection depth counter for the connection associated with the data transmission unit; and

(c) decrementing by one a partition depth counter for each Partition associated with the data transmission unit.

### BRIEF DESCRIPTION OF THE DRAWINGS

The invention will now be described with reference to the drawings, in which:

FIG. 1 is a block diagram of a data traffic management system according to a first embodiment of the present invention;

FIG. 2 illustrates the elements of the congestion management system and their hierarchy according to a first embodiment of the present invention;

FIG. 3 shows a representation of a connection data structure according to a first embodiment of the present invention;

FIG. 4 shows a representation of a partition data structure according to a first embodiment of the present invention;

FIG. 5 illustrates the elements of the congestion management system and their hierarchy according to a second embodiment of the present invention;

FIG. 6 shows a representation of connection data structure according to a second embodiment of the present invention;

FIG. 7 shows a representation of a partition data structure according to a second embodiment of the present invention;

FIG. 8 is a flowchart detailing the process for controlling the access of a DTU at the connection level according to a third embodiment of the present invention;

FIG. 9 is a flowchart detailing a subprocess for determining if access is permitted to the incoming DTU according to a third embodiment of the present invention;

FIG. 10 is a flowchart detailing a subprocess for accepting incoming DTUs according to a third embodiment of the present invention;

FIG. 11 is a flowchart detailing a process for controlling access of a DTU at the connection level according to a fourth embodiment of the present invention;

FIG. 12 is a flowchart detailing a subprocess determining if access is permitted to the DTU according to a fourth embodiment of the present invention; and

FIG. 13 is a flowchart detailing a process for updating the congestion management system upon departure of a DTU according to a fifth embodiment of the present invention.

### DETAILED DESCRIPTION

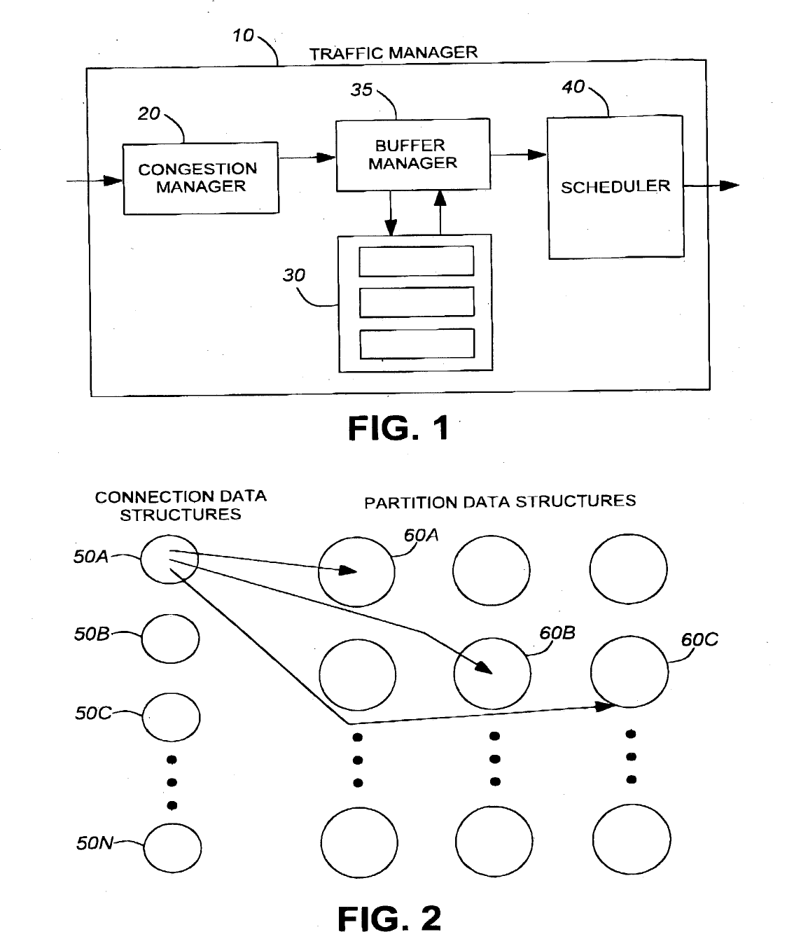

FIG. 1 is a block diagram of a data traffic management system 10. The data traffic management system includes a congestion management system 20, a pool of buffer memory 30 managed by the buffer management system 35 and a scheduler 40. The congestion management system 20 is located on the input side of the data traffic management system 10. As DTUs arrive at the input port of the data traffic management system, the congestion management system 20 determines whether a DTU can be stored in the pool of buffer memory 30. The buffer management system 35, coupled to the congestion management system 20, stores incoming DTUs in the buffer and later retrieves them for further processing. Although the congestion management system 20 initially receives DTUs, the buffer management system 35 is solely responsible for storing the DTUs in the buffer memory 30. The congestion management system 20 can also control the access of a DTU to such destinations as an output port or a data traffic queue. An output port or a data traffic queue are some of the possible destinations for some of the incoming DTUs. On the output side of the data traffic management system 10, the scheduler 40 is coupled to the buffer management system 35. The scheduler 40 determines when the DTUs will be retrieved from the pool of buffer memory by scheduling their departure from the data traffic management system.

Each incoming DTU is associated with a specific connection and each connection has a connection data structure associated with it. Each connection represents a data path from the origin to multiple destinations, where the destination is determined by the DTU and where the connection data structure represents a connection. The congestion management system monitors each connection associated with an incoming DTU using the connection data structure for each connection that is maintained in the congestion management system. The connection data structure is a data construct used by the congestion management to monitor the number of DTUs arriving at the input port of the data traffic management. Each connection references at least one destination in the data traffic management system. The congestion management system also maintains a partition data structure as each of the DTUs servicing a particular destination is grouped into a partition. A partition is a possible representation of the destinations for a DTU coming in on a connection. For a given DTU there is only a single connection yet there may be several partitions associated with that DTU.

FIG. 2 is a schematic diagram of elements in the congestion management system and their interrelationship within the system. The first set of components shown are the connection data structures 50A, 50B, 50C, . . . 50N. Each connection component 50A, 50B, 50C, . . . 50N represents a connection of incoming DTUs. The connection data structure maintains information such as the number of DTUs that are currently active on the connection. Connection data structure 50A is associated with partition data structures [60A,60B, 60C], each connection data structure references a partition data structure using a pointer. Each partition has a corresponding partition data structure in the congestion management system. Each connection data structure contains a number of pointers with each pointer referencing a partition data structure that is associated with the particular connection which is represented by the connection data structure.

In order to accept a DTU, the congestion management system must determine whether there are available resources at both the connection level and the partition level. Thus, to accept a DTU, the relevant connection data structure and the relevant partition data structure must both be able to accept another entry. Based on the number of DTUs active on a connection and the partitions referenced by the connection, DTUs will either be accepted or discarded from the congestion management system.

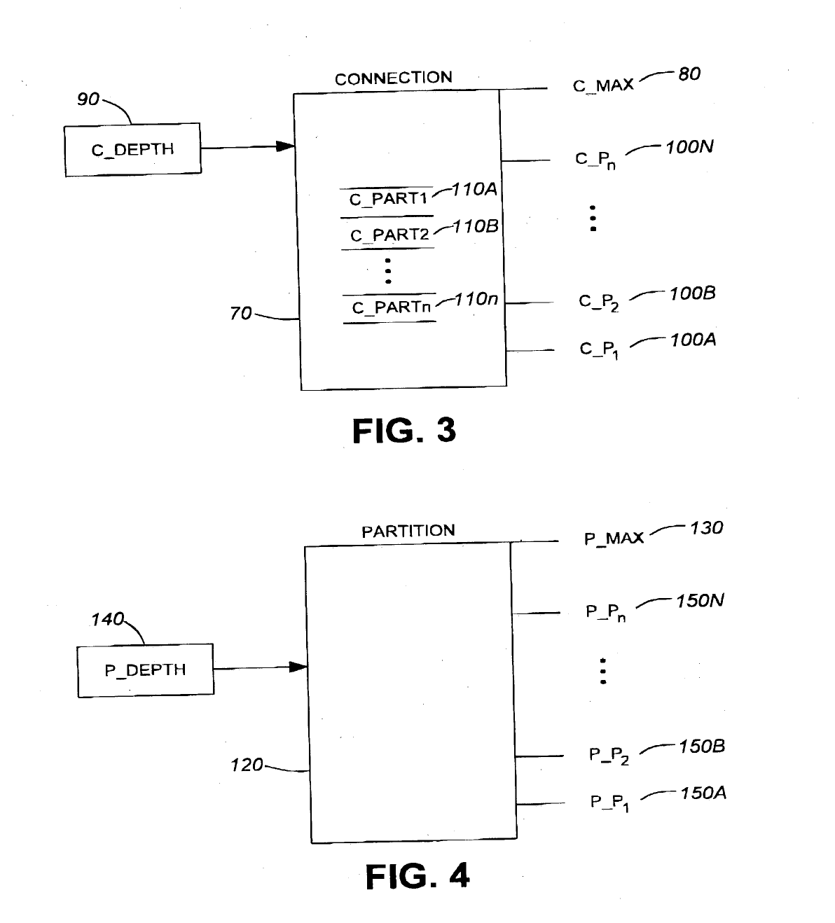

FIG. 3 is a representation of a connection data structure 70 consisting of counters, thresholds and pointers. Each connection data structure has a maximum backlog threshold (C_MAX) 80. The C_MAX threshold is defined as the maximum number of DTUs that may be active on the connection. The connection data structure maintains a connection depth counter (C_Depth) 90 which monitors the instantaneous number of DTUs active for that connection. The connection data structure having a number connection priority level thresholds (C_P₁, C_P₂, . . . , C_Pn) as 100A, 100B, . . . 100N in which each connection priority level threshold corresponds to a priority level assignable to a DTU. As each incoming DTU may have a different priority level, the number of DTUs for each priority level active on a connection is monitored within each connection data structure. The connection data structure ensures that DTUs with a low priority level are not accepted while DTUs of a high priority level are denied access at a connection level.

The connection priority level threshold enforced determines which DTUs will be accepted. If a DTU has a priority level higher than the connection priority level threshold enforced, then that DTU will be accepted. Otherwise, it will be rejected. Upon arrival of a DTU, the congestion management system identifies the priority level of that DTU. The congestion management system retrieves the corresponding connection priority level threshold for a given connection and then compares the connection priority level threshold to C_Depth 90. If C_Depth 90 is lower than the counter priority level threshold then the DTU is accepted at the connection level, otherwise it is rejected. The C_Depth counter 90 is incremented by one each time an incoming DTU is accepted at both the connection level and the partition level. Conversely, the C_Depth counter 90 is decremented by one each time a DTU departs from a particular resource. Upon departure of the DTU from the resource, the relevant counters from the connection data structure and the partition data structure are decremented. This is the effective equivalent of the DTU departing at both the connection level and the partition level.

For example, if a given DTU had a priority level of one then the connection priority level threshold C_Pl 100A is identified. The C_Pl 100A threshold is compared with the moot recent count of the C_Depth 90 counter. If the threshold is higher than the count in C_Depth then the DTU is accepted at the connection level. If accepted, the congestion management system must now determine if the DTU can be accepted for all partitions referenced by the connection. C_MAX 80 is the maximum number of DTUs that may be active on a particular connection. The count maintained in the C_Depth counter 90 must never surpass the C_MAX threshold 80. The connection data structure 70 has a number of pointers 110A, 110B, . . . , 110N which indicate which partitions are associated with a given connection. Pointer C_Part 1 110A references the first partition, Pointer C_Part 2 110B references the second partition, and finally C_PartN 110N references a final partition associated with the connection. Thus if the DTU is accepted, each of the partitions referenced by pointers C_Part1 . . . C_Partn as 110A . . . 110N are to be checked to see if they can accept another DTU. If one of these partitions rejects the DTU, then the DTU is rejected at the partition level. If a DTU is rejected at one or both of the connection or partition levels, the DTU is finally rejected.

FIG. 4 illustrates a partition data structure 120 similar to that of the connection data structure 70 in FIG. 3. The partition data structure for a partition can represent any object in the data traffic management system, such as a buffer memory pool, an output port, or an input port. Each partition data structure also has a maximum partition threshold (P_Max) 130. The P_Max threshold 130 is the maximum number of DTUs that may be active on a particular partition. The P_Max threshold is predetermined by the congestion management system, along with all the other thresholds. The P_Max threshold 130 is the maximum number of active DTUs allowed on each partition. The partition data structure maintains a partition depth counter (P_Depth) 140 which monitors the number of active DTUs on the partition. The priority levels of each DTU are also important as the partition level The partition data structure maintains a number of partition priority level thresholds (P_P₁, P_P₂, . . . , P_Pn) as [150A, 150B, . . . , 150N] in which each partition priority level threshold corresponds to a priority level assignable to a DTU. These priority level thresholds must be checked to determine whether an incoming DTU is to be accepted or rejected at the partition level. Although the incoming DTU was accepted at the connection level, it is not indicative of whether or not a DTU will be accepted at the partition level. The connection level and the partition level must both be checked to determine whether or not access will be allowed to a particular DTU.

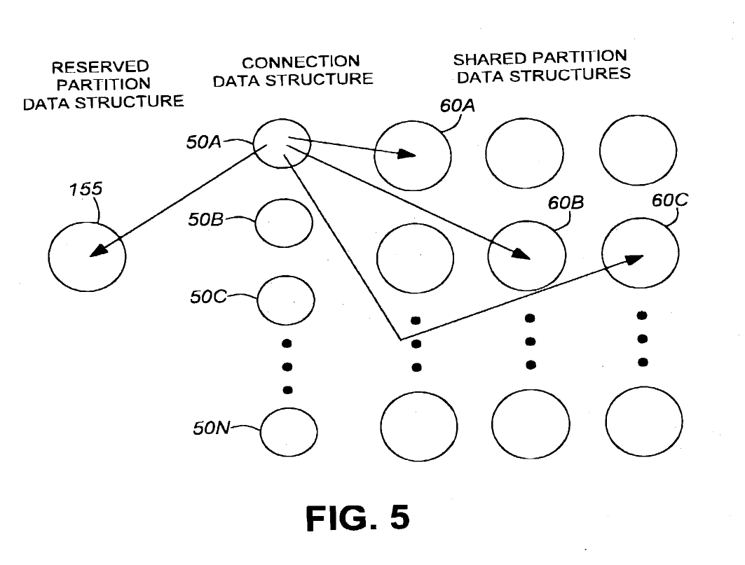

FIG. 5 is a schematic diagram of elements in the congestion management system and their interrelationship within the system according to another embodiment. As in FIG. 3, the connection data structure 50A is associated with a number of shared partition data structures 60A, 60B, 60C. The connection data structures 50A, 50B, 50C, . . . , 50N may also be associated with a reserved partition 155. A reserved partition represents a reserved resource which is assignable to a DTU coming in on a connection. Accordingly, the reserved connection 50A is shown as referencing the reserved partition 155. Each DTU may be allocated a share of the reserved resource instead of competing with other DTUs of varying priority levels for the shared resources which are represented by the partitions. A DTU assigned to the reserved partition would be automatically allowed access to the reserved resource if the amount of DTUs active on the reserved partition was not greater than a reserved partition threshold.

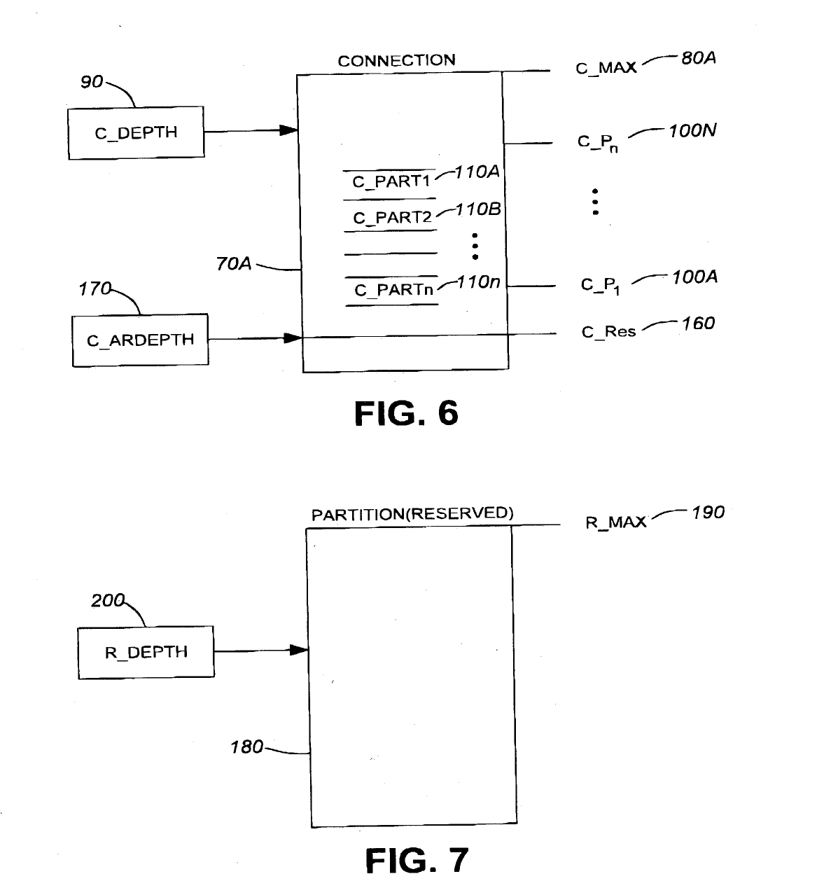

As an alternative to the connection data structure illustrated in FIG. 3, FIG. 6 is a representation of a connection data structure 70A consisting of a reserved area and a shared area. The reserved area is defined by the connection reserved threshold (C_RES) 160. The C_RES threshold 160 is the maximum number of DTUs active on a reserved connection. The shared area of the connection data structure 70A is similar to the connection data structure 70 of FIG. 3. The connection data structure 70A maintains a connection depth counter (C_Depth) 90A. The C_Depth counter 90A monitors the number of DTUs active on that connection. The maximum backlog threshold (C_MAX) is the maximum number of DTUs active on the connection. The count maintained in the C_Depth counter 90A must never surpass the C_MAX threshold 80. The C_MAX threshold reflects the maximum number of DTUs that may be active on a given connection. In order to accept a DTU at the reserved connection level, an incoming DTU must be identified as having a reserved status. If a reserved status has been assigned to a particular DTU, then an initial step must be performed to determine whether there are available reserved resources on a reserved connection based on the C_RES threshold. If the reserved resources are available, then the DTU is accepted at the connection level. Prior to allowing access to the DTU accepted at the connection level, a further step is required to determine if the DTU can be accepted at the partition level.

All the threshold levels are predetermined by the congestion management system, so that these levels reflect the capacity of available resources in the data traffic management system for DTUs of different priorities. The shared area has a number of connection priority level thresholds (C_DP1, . . . , C_DPn) as [100A, . . . , 100N] in which each connection priority level threshold corresponds to a priority level assignable to a DTU. To accept a DTU with a certain priority level, the connection priority level threshold which corresponds to the priority level that the DTU has must be greater than the count in C_Depth 90A. If the connection priority level threshold in equal to or less than the connection depth count, then the DTU must be rejected. The C_Depth counter 90A is incremented each time an incoming DTU is accepted at both the connection level and the partition level. The connection data structure 70A maintains a series of pointers (C_PART1, C_PART2, . . . , C_PARTn) as (110A, 110B, . . . , 110N). Similar to the pointers in FIG. 3, these pointers reference partitions which are associated with the connection. A reserved connection depth counter (C_ARDepth) maintains a count within the reserved area of the connection data structure in which C_ARDepth is the number of DTUs active on the reserved partition.

FIG. 7 is a representation of the reserved partition data structure 180. A connection may be associated with the reserved partition if that connection has DTUs which are destined for the reserved resources. The partition data structure defines a reserved partition maximum threshold (R_MAX) 190. The R_MAX threshold 190 is the maximum number of DTUs that may be active on the reserved partition. A reserved partition depth counter (R_Depth) 200 maintains a count that monitors the number of DTUs currently on the reserved partition. The R_Depth 200 count may not exceed the R_MAX threshold 190. If the R_MAX threshold is equal to the R_Depth count then the congestion management system is denied permission to accept any more DTUs until such time as the R_Depth 200 count decreases. The R_Depth amount is incremented by one every time a DTU is accepted on the reserved partition. Conversely, the R_Depth count is decremented by one every time a DTU departs from the reserved partition.

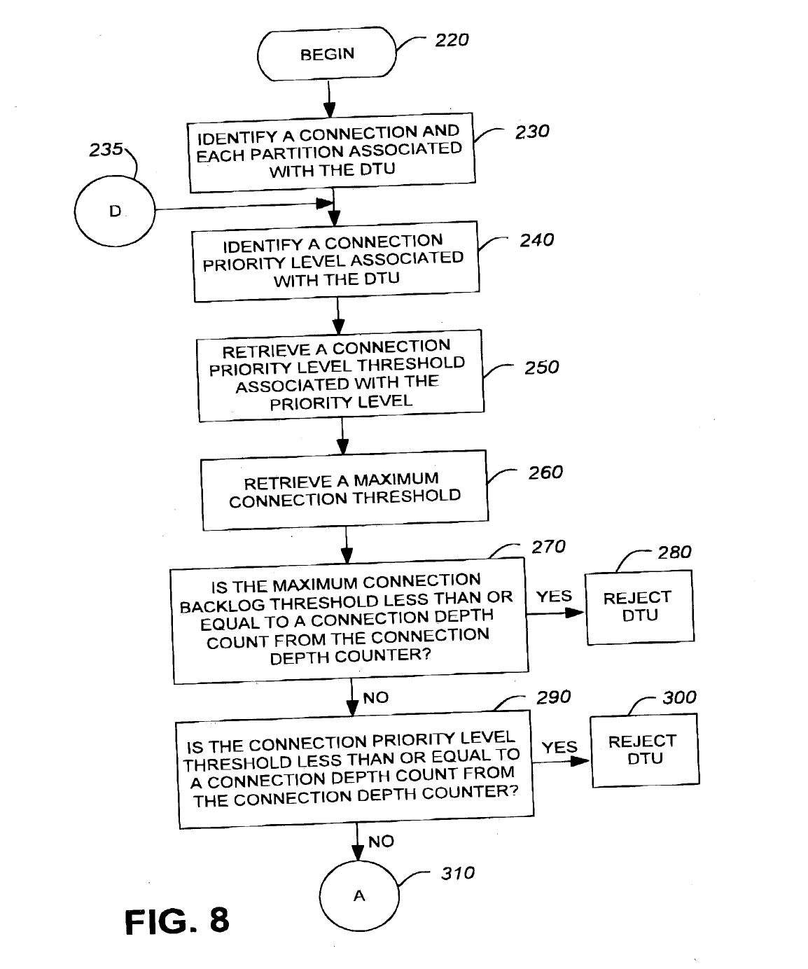

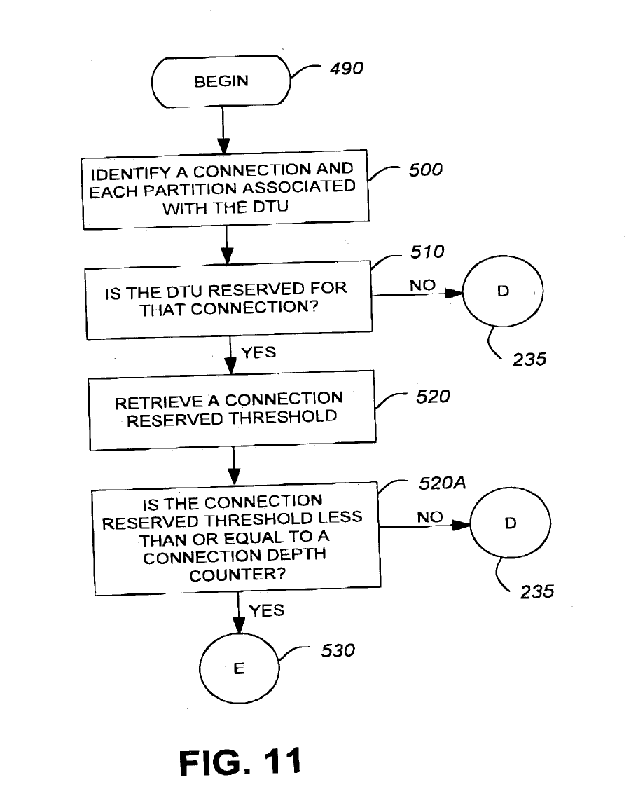

FIG. 8 is a flowchart representing the steps in a method for controlling access of a DTU at the connection level. The process begins at step 220 and is followed by step 230 which identifies a connection and at least one partition associated with the DTU. The connector D 235 follows from step 230 and will be explained in conjunction with FIG. 11. The next step 240 is to identify a connection priority level associated with the DTU in order to retrieve a connection priority level threshold in step 250. The processor in the congestion management system retrieves the connection priority level. Next, step 260 retrieves a maximum connection level threshold using the processor. The next step 270 determines if the maximum connection threshold, retrieved in step 260, is less than or equal to the current count in the connection depth counter. If yes, then the DTU is rejected at the connection level in step 280. If not, then the next step 290 determines if the connection priority level threshold, retrieved in step 250, is less than or equal to the current count in the connection depth counter. If yes, then again the DTU is rejected at the connection level in step 300. If not, then the process follows connector A 310 to determine if the DTU should be allowed access at the partition level.

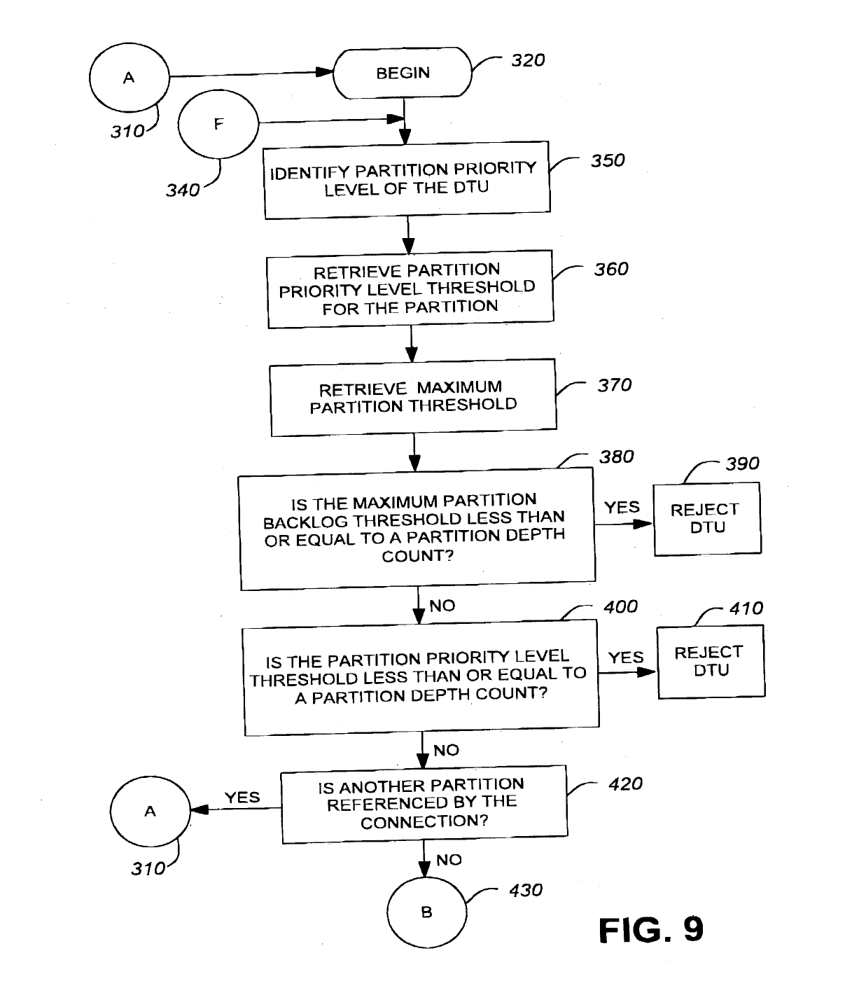

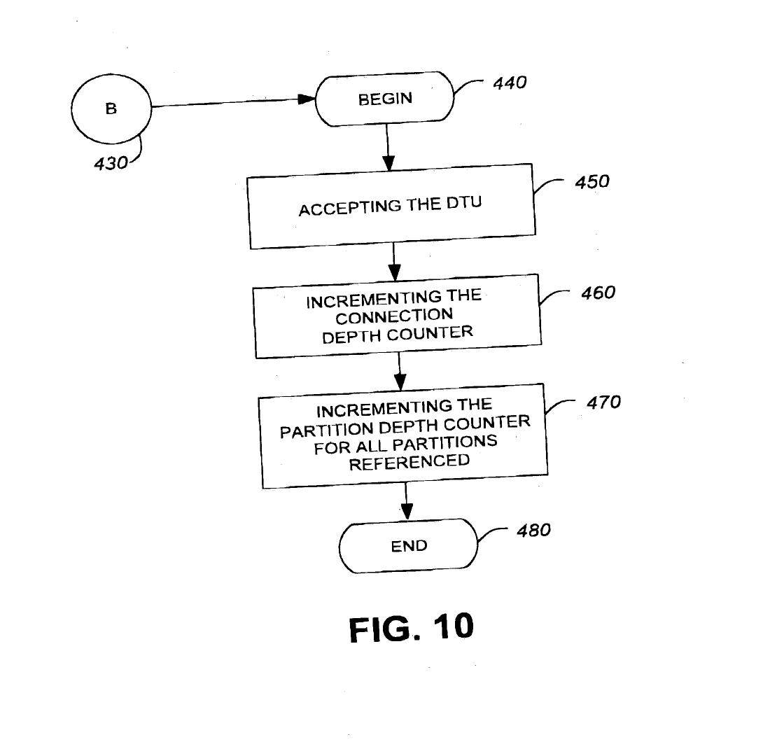

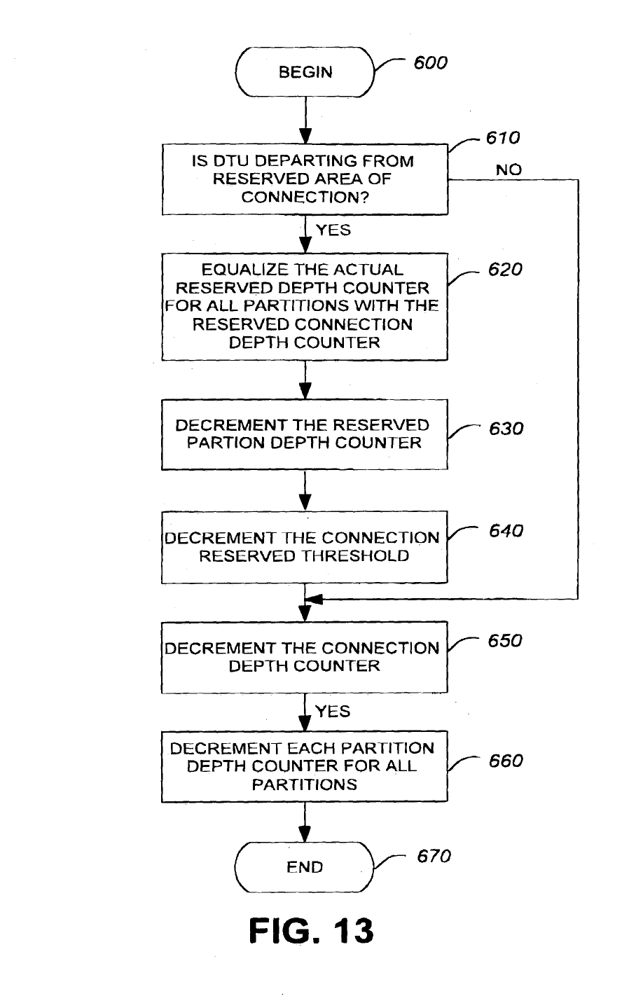

FIG. 9 follows connector A 310 which begins a new process at step 320. The flowchart illustrates the steps in the method for determining if access is permitted to the incoming DTU at the partition level. Connector F 340, shown following step 320, will be explained in further detail in conjunction with the flowchart of FIG. 13. Connector F 340 is an optional step that is applicable only if the connection data structure has a reserved partition and if a reserved partition data structure exists. Following step 320, step 350 identifies the partition priority level of the DTU. The connection data structure uses its own pointer to reference the relevant partition data structure. Once the partition priority level is identified, step 360 retrieves the partition priority level threshold predetermined for the partition data structure. In step 370 a maximum partition threshold is retrieved from the processor. Step 380 determines if the maximum partition threshold is less than or equal to a current count maintained in the partition depth counter. If yes, then the DTU is rejected at the partition level in step 390. Although the DTU was not rejected at the connection level, this process is crucial in determining if resources are available at the partition level. Resources are then made available for additional DTUs if the amount of DTUs active on a partition has not surpassed the maximum partition backlog threshold for all partitions. If the condition in step 380 is not met, then step 400 determines if a partition priority level threshold which is equal to or less than a current count from the partition depth counter. If yes, then the DTU is rejected at the partition level in step 410. If not, then step 420 determines if another partition is referenced by the connection. If yes, then connector A is followed to repeat steps 320 to 420. If not, then connector B 430 is followed back to the process in FIG. 10.

In FIG. 10 is a flowchart illustrating the steps in a method for accepting the incoming DTU based on the conditions met in previous steps. FIG. 10 follows connector B 430 which begins a new process at step 440. The step 450 permits the congestion management system to accept the DTU. The next step 460 increments the connection depth counter by one. Step 470 increments by one the partition depth counter for all partitions. Both counters are incremented by one once the DTU has been accepted at both the connection level and the partition level. The process that began at step 220 ends at step 430.

FIG. 11 is a flowchart illustrating the steps in a method where the congestion management system maintains a connection data structure that has a reserved area and also has a reserved partition data structure. The process begins at step 490 and is followed by step 500 which identifies the connection associated with the DTU and each partition associated with that connection. The next step 510 determines if the DTU has a reservation on that connection. If the DTU is not reserved then connector D 235 is followed back to the steps included in the method of FIG. 8. Although this embodiment of the congestion management system differs from the embodiment illustrated in FIG. 8, the steps in the method are the same. If the DTU has a reservation on the connection, then step 520 retrieves a connection reserved threshold which is predetermined for that connection by the congestion management system. The next stop 520 determines if the connection reserved threshold is less than or equal to a current count of the connection depth counter. If no, then connector D 235 is followed to begin a process at step 240 in FIG. 8. Since the DTU was not accepted into the reserved area of the connection, access will be determined for the shared area of the connection. If the connection reserved threshold is greater than a current count of the connection depth counter, then the process follows connector E 530.

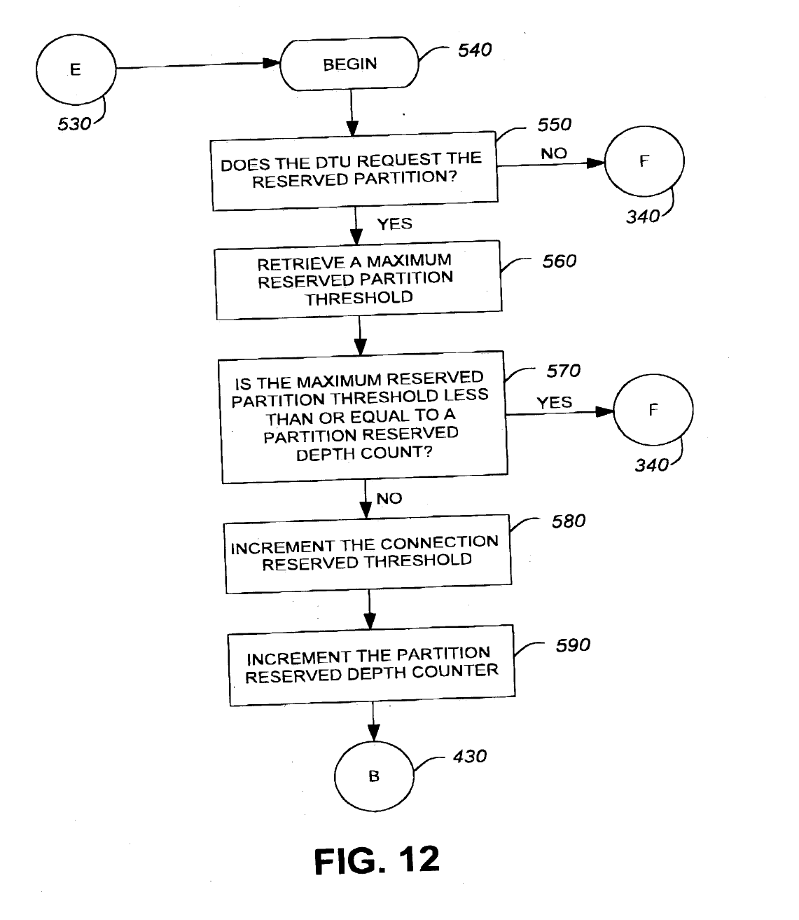

FIG. 12 follows connector E 530 which begins a new process at step 540. Step 550 determines if the DTU requests a reservation on the reserved partition. If the DTU does not request such a reservation then connector F 340 is followed which continues the process in FIG. 9 beginning at step 330. If a reservation is requested, then a maximum reserved partition threshold is retrieved in step 560. Step 570 determines if the maximum reserved partition threshold is less than or equal to a current count in the partition reserved depth counter. If yes, then follow connector 340 to continue the process for all partitions since the partition reserved depth counter indicates that the reserved partition has attained the maximum allowable amount of DTUs. If not, then follow step 580 and increment by one the connection reserved threshold. In step 590, the partition reserved depth counter is incremented by one. Connector B is followed to FIG. 10 to increment by one the other remaining counters and finally accept the DTU into the congestion management system.

FIG. 13 is a flowchart illustrating the steps in a method for updating the congestion management system upon departure of a DTU. The process begins with step 600 and is followed by step 610 for determining if the DTU is departing from the reserved area of a connection. If yes, then the processor will equalize the actual reserved depth counter for all partitions with the reserved connection depth counter in step 620, such that the count in the actual reserved depth counter is the same as the count in the reserved connection death counter. Next, the processor decrements by one the reserved partition depth counter in step 630. In step 640, the processor decrements the connection reserved threshold. If, from step 610, the DTU is not departing from the reserved area of a connection then step 650 is followed. In the process, step 650 decrements by one the connection depth counter. Step 660 decrements by one each partition depth counter for all partitions associated with the DTU. The process that began at step 600 ends at step 670.

The congestion management system of the present invention may be implemented in various buffer management systems. Such implementations include ATM switch buffer management, Frame Relay switch buffer management, MPLS switch buffer management and IP router buffer management.

We claim:

1. A congestion management system for controlling access of data transmission units to a plurality of shared resources, each data transmission unit having a priority level and being associated with a connection, and each shared resource being represented by a partition, the congestion management system including:
(a) a plurality of connection data strictures, each connection data structure representing a connection, and each connection data structure having:
(a1) a connection depth counter which indicates a number of data transmission units currently active on the connection,
(a2) a predetermined number of connection priority level thresholds, each connection priority level threshold corresponding to a priority level assignable to a data transmission unit, and each connection priority level threshold being determinative of whether an incoming data transmission unit may be allowed on the connection based on a priority level of the incoming data transmission unit,
(a3) a maximum connection threshold indicating a maximum number of data transmission units that may be active at any one time on the connection, and
(a4) at least one pointer, the or each pointer referencing a partition associated with a connection represented by the connection data structure;
(b) a plurality of partition data structures, each partition data structure representing a partition, and each partition data structure having:
(b1) a partition depth counter which indicates a number of data transmission units currently active on the connection,
(b2) a predetermined number of partition priority level thresholds, each partition priority level threshold corresponding to a priority level assignable to a data transmission unit, and each partition priority level threshold being determinative of whether an incoming data transmission unit may be allowed on the connection based on the priority level of the incoming data transmission unit,
(b3) a maximum partition threshold indicating a maximum number of data transmission units that may be active at any time on a partition; and
(c) processing means for determining whether an incoming data transmission unit is allowed on a specific connection and a specific partition based on the priority level of the incoming data transmission unit, a connection priority level threshold, and a partition priority level threshold, for updating the plurality of connection data structures and updating the plurality of partition data structures when an incoming data transmission unit is allowed.

2. A system as defined in claim 1, wherein each connection data structure contains a reserved area, the reserved area having a connection reserved threshold corresponding to a reserved status assignable to a data transmission unit such that a DTU having a reserved status is allowed access to a connection, and the reserved area having an actual reserved depth counter which indicates a number of DTUs currently active in the reserved area.

3. A system as defined in claim 2, wherein the congestion management system includes a reserved partition data structure to represent a reserved partition, the reserved partition data structure having a reserved partition depth counter which indicates a number of DTUs currently active in the reserved partition.

4. A system as defined in claim 1, wherein the plurality of shared resources includes a pool of buffer memory.

5. A system as defined in claim 4, wherein a partition represents an object selected from the group consisting of:
(a) an output port, and
(b) an input port.

6. A method for controlling access of a data transmission unit to at least one destination, the or each destination is represented by a partition, the data transmission unit being associated with a connection, the method including the steps of:
(a) determining if the data transmission unit can be accepted at the connection,
(b) determining if the data transmission unit can be accepted at the or each partition,
(c) if the data transmission unit is rejected at either the connection or at least one partition, rejecting the data transmission unit, and
(d) if the data transmission unit is accepted at the connection and at the or at all the partitions, accepting the data transmission unit such that the data transmitted unit is granted access to the or each destination.

7. A method as defined in claim 6, further including an initial step of determining if the data transmission unit can be accepted at a reserved partition, the initial step being executed prior to step (a), such that if the data transmission unit is accepted at the reserved partition, accepting the data transmission unit such that the data transmitted unit is granted access to the or each destination.

8. A method for updating a data traffic management system upon departure of a data transmission unit, the method including:
(a) identifying a connection and at least one partition associated with a departing data transmission unit,
(b) decrementing by one a connection depth counter for the connection associated with the data transmission unit; and
(c) decrementing by one a partition depth counter for each partition associated with the data transmission unit.
